(19) United States
(12) Patent Application Publication
(10) Pub. No.: US 2003/0140605 A1
(43) Pub. Date: Jul. 31, 2003

(54) Stirrup with clamped shock-absorbing pads

(76) Inventor: Chang Hsi-Chang, Taichung (TW)

Correspondence Address: Antonio R. Durando, Durando Birdwell & Janke, P.L.C., 2929 E. Broadway Blvd., Tucson, AZ, 85716, US

(21) Appl. No.: 10/056,561

(22) Filed: Jan. 25, 2002

(51) Int. Cl. B68C 3/00

(52) U.S. Cl. 54/48

(57) ABSTRACT

A stirrup includes a footrest which is attached to a hanger for suspending the stirrup from a saddle. The footrest has an opening which accommodates a shock-absorbing element while a second shock-absorbing element is positioned on the footrest outside of the opening. The shock-absorbing elements are held on the footrest by two clamping elements which are discrete from the footrest and the shock-absorbing elements.

### BACKGROUND OF THE INVENTION

1. Field of the Invention

The invention relates to a stirrup.

2. Description of the Prior Art

Stirrups come in different forms. One known type of stirrup includes a metallic footrest which is connected to a metallic hanger for suspending the stirrup from a saddle. The footrest is provided with an opening which receives a shock absorber in the form of a single rubber or plastic pad. The pad has a surface which faces upward during use, and this upper pad surface is nonslip to prevent the foot of a rider from sliding out of the stirrup.

The footrest has generally flat upper and lower surfaces, and the pad includes an upper portion which rests on and bears against the upper footrest surface. The pad further includes an intermediate portion which sits in the opening of the footrest, and a lower portion constituted by two flaps which project to opposite sides of the pad. The flaps bear against the lower footrest surface and cooperate with the upper portion of the pad to fix the latter on the footrest. The pad is mounted on the footrest by bending the flaps towards one another, passing the flaps through the opening of the footrest and then releasing the flaps. The pad may be removed from the footrest by again bending the flaps towards each other and thereupon pushing the pad out of the opening.

The type of stirrup just described has very little versatility. Thus, a rider is limited to the characteristics of the pad and is unable to select a particular combination of characteristics at will, e.g. a particular combination of shock absorbing and frictional properties.

### SUMMARY OF THE INVENTION

It is an object of the invention to enhance the versatility of a stirrup.

The preceding object, as well as others which will become apparent as the description proceeds, are achieved by the invention.

One aspect of the invention resides in a stirrup. The stirrup comprises a support for a foot, at least one shock-absorbing element, and means for releasably clamping the shock-absorbing element to the support. The clamping means is discrete from the shock-absorbing element. By way of example, the shock-absorbing element may be in the form of a member inflated with gas, e.g., air.

Inasmuch as the shock-absorbing element is separate from the means for mounting the shock-absorbing element on the foot support, different options are available to a rider. For example, a nonslip surface can be formed on the clamping means rather than on the shock-absorbing element. Another possibility is to fix two shock-absorbing elements of different material to the foot support by way of the clamping means. Thus, the stirrup of the invention can be designed to have any of a number of different combinations of characteristics.

Another aspect of the invention resides in a method of assembling a stirrup. The method comprises the steps of providing a support for a foot, and releasably clamping at least one shock-absorbing element to the support using clamping means discrete from the shock-absorbing element.

The shock-absorbing element may be formed with a recess while the foot support is provided with a suspending element for suspending the support from a saddle. The method can here further comprise the step of inserting the suspending element in the recess to position the shock-absorbing element on the support.

It is also possible to provide the shock-absorbing element with a rib and to form the foot support with an opening. The method may then comprise the step of inserting the rib in the opening to position the shock-absorbing element on the support.

The clamping means may comprise a clamping element having a section with a nonslip surface, and the clamping step may here include recessing this section in the shock-absorbing element.

The clamping means may comprise a first clamping element and a second clamping element. In such an event, the clamping step can include urging the first clamping element against the shock-absorbing element and urging the second clamping element against the foot support. Each of the clamping elements preferably consists of plastic or predominantly of plastic.

The clamping step can further include urging the shock-absorbing element against the support. The clamping step may also include locking the first clamping element and the second clamping element to one another.

As mentioned above, the foot support can be formed with an opening. The second clamping element may then be provided with a protuberance which can be inserted in the opening to position the second clamping element on the support.

One of the clamping elements can be formed with at least one pair of legs and the other clamping element may be provided with an aperture for the legs. Here, the clamping step can include resiliently urging the legs towards one another, passing both of the legs through the aperture, and allowing the legs to resiliently spring back from one another so as to fix the shock-absorbing element to the foot support by snap action.

At least one of the legs may have a free end and a projection at this end extending away from the other of the legs. The clamping step can then include recessing the projection in the clamping element with the aperture.

The clamping element with the legs may have two pairs of legs and the shock-absorbing element may be provided with two apertures. Under such circumstances, the clamping step can comprise passing each of legs through a respective aperture of the shock-absorbing element, resiliently urging the legs of each pair towards one another, and allowing the legs of each pair to resiliently spring back from one another so as to fix the shock-absorbing element to the foot support by snap action.

As indicated earlier, the foot support can be provided with an opening. The method may then comprise the step of recessing an additional shock-absorbing element in the opening, and the clamping step may involve confining the additional shock-absorbing element in the opening using the first-mentioned shock-absorbing element.

Additional features and advantages of the invention will be forthcoming from the following detailed description of specific embodiments when read in conjunction with the accompanying drawings.

### BRIEF DESCRIPTION OF THE DRAWINGS

FIG. 1 is perspective view of a stirrup in accordance with the invention.

FIG. 2 is a section in the direction of the arrows II-II of FIG. 1 and contains a top view of a footrest constituting part of the stirrup of FIG. 1.

FIG. 3 is a bottom view of the footrest.

FIG. 4 is an exploded perspective view of a shock-absorbing unit constituting part of the stirrup of FIG. 1.

FIG. 5 is a top view of a shock-absorbing element forming part of the shock-absorbing unit of FIG. 4.

FIG. 6 is a bottom view of the shock-absorbing element of FIG. 5.

FIG. 7 is a sectional view of the shock-absorbing element of FIG. 5 as seen in the direction of the arrows VII-VII of FIG. 5.

FIG. 8 is a perspective view of a clamping device constituting part of the shock-absorbing unit of FIG. 4 and serving to fix the shock-absorbing unit to the footrest in the stirrup of FIG. 1.

FIG. 9 is a perspective view of a clamping element forming part of the clamping device of FIG. 8.

FIG. 10 is a side view of the clamping element of FIG. 9.

FIG. 11 is a sectional view of the clamping element of FIG. 9 as seen in the direction of the arrows XI-XI of FIG. 10.

FIG. 12 is a perspective view of another clamping element constituting part of the clamping device of FIG. 8.

FIG. 13 is a top view of the clamping element of FIG. 12.

FIG. 14 is a sectional view of the clamping element of FIG. 12 as seen in the direction of the arrows XIV-XIV of FIG. 13.

### DESCRIPTION OF THE PREFERRED EMBODIMENTS

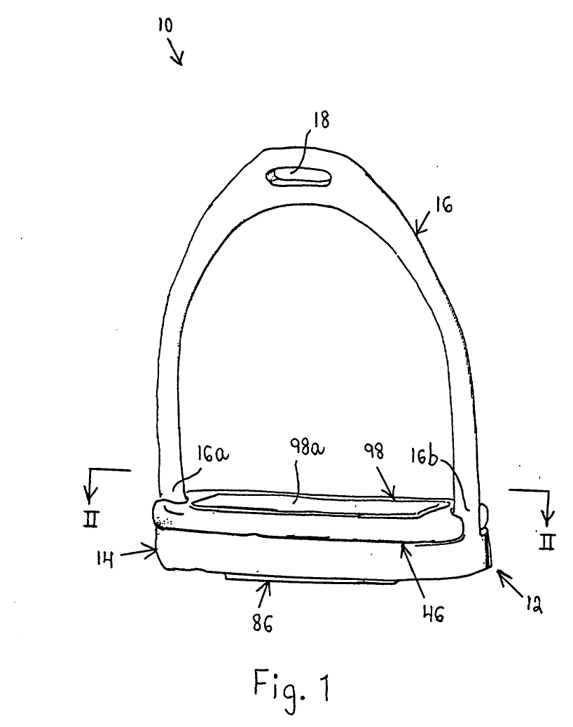

Referring to FIG. 1, the numeral 10 identifies a stirrup according to the invention. The stirrup 10 includes a metallic carrying member 12 having a footrest 14 which constitutes a support for a foot. The carrying member 12 further has a U-shaped hanger or suspending element 16 which is of one piece with the footrest 14 and serves to suspend the stirrup 10 from a saddle. The hanger 16, which is centered with respect to the footrest 14 laterally of the latter, is provided with a slot 18 for attaching the hanger 16 to the saddle.

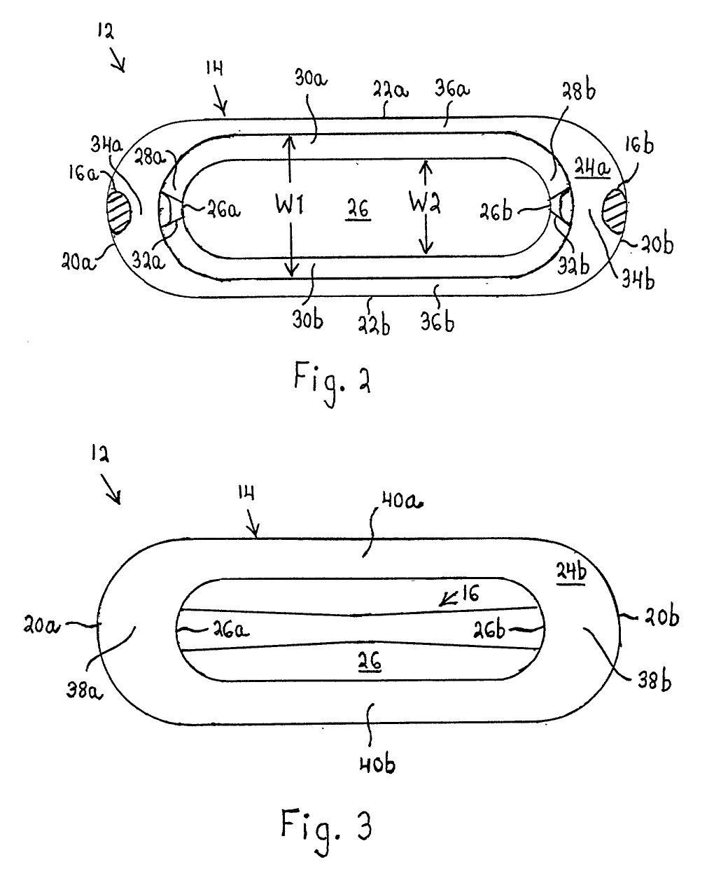

Considering FIGS. 2 and 3 with FIG. 1, the footrest 14 is elongated and has convex opposed longitudinal ends 20a and 20b. The footrest 14 further has two opposed longitudinally extending sides 22a and 22b which bridge the longitudinal ends 20a,20b, and the sides 22a,22b are straight and parallel to one another. In addition, the footrest 14 has two flat parallel surfaces 24a and 24b lying in respective planes which are generally perpendicular to the straight sides 22a and 22b. The flat surfaces 24a,24b face in opposite directions, and the straight sides 22a,22b run from one of the flat surfaces 24a,24b to the other. In use, the flat surface 24a faces up and can be considered to be an upper surface of the footrest 14 while the flat surface 24b faces down and can be considered to be a lower surface of the footrest 14.

The footrest 14 is formed with an elongated opening 26 having a shape similar to that of the footrest 14. The opening 26 has opposed longitudinal ends 26a and 26b, and the longitudinal end 26a of the opening 26 is located in the vicinity of the longitudinal end 20a of the footrest 14 while the longitudinal end 26b of the opening 26 is located in the vicinity of the longitudinal end 20b of the footrest 14. The elongated opening 26 extends from the upper surface 24a of the footrest 14 to the lower surface 24b and is bounded by a sloping wall. This wall has a concave segment 28a at the longitudinal end 26a of the opening 26 and a concave segment 28b at the longitudinal end 26b of the opening 26. The sloping wall further has two opposed straight segments 30a and 30b which face each other and run in the same direction as the straight sides 22a,22b of the footrest 14. Each of the segments 30a,30b extends from one of the concave segments 28a,28b to the other.

A protrusion 32a is formed at the center of the concave wall segment 28a whereas a second protrusion 32b is formed at the center of the concave wall segment 28b. The protrusions 32a,32b are part-circular in cross section and run from one of the flat surfaces 24a,24b of the footrest 14 to the other. The radii of the protrusions 32a,32b decrease progressively from the flat surface 24a to the flat surface 24b. The protrusions 32a,32b are centered with respect to the footrest 14 laterally of the latter.

The sloping wall 28a,28b,30a,30b bounding the elongated opening 26 in the footrest 14 slopes in such a manner that the cross-sectional area of the opening 26 at the upper surface 24a of the footrest 14 exceeds the cross-sectional area at the lower surface 24b. The elongated opening 26 has a maximum width W1 at the upper surface 24a and a smaller maximum width W2 at the lower surface 24b. Both the cross-sectional area and the maximum width of the elongated opening 26 decrease progressively from the upper surface 24a to the lower surface 24b.

The upper surface 24a of the footrest 14 is made up of two curved sections 34a and 34b and two straight, strip-like sections 36a and 36b. The curved sections 34a,34b are respectively located at the longitudinal ends 26a,26b of the opening 26 in the footrest 14 while the strip-like sections 36a,36b run along opposite sides of the opening 26. Each of the strip-like sections 36a,36b bridges the curved sections 34a,34b.

In a similar fashion, the lower surface 24b of the footrest 14 is made up of two curved sections 38a and 38b and two straight, strip-like sections 40a and 40b. The curved sections 38a,38b are respectively located at the longitudinal ends 26a,26b of the opening 26 in the footrest 14 while the strip-like sections 40a,40b run along opposite sides of the opening 26. Each of the strip-like sections 40a,40b bridges the curved sections 38a,38b.

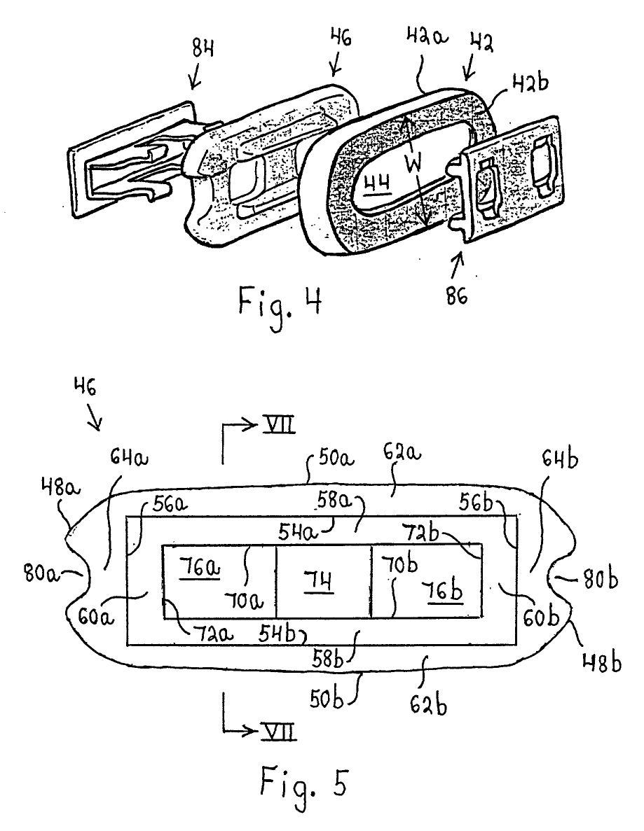

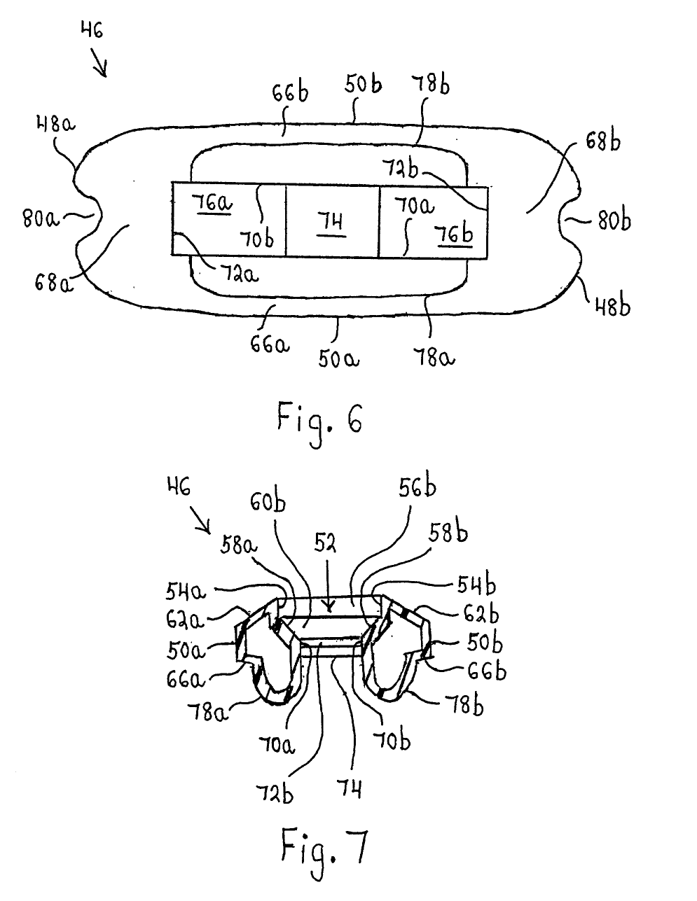

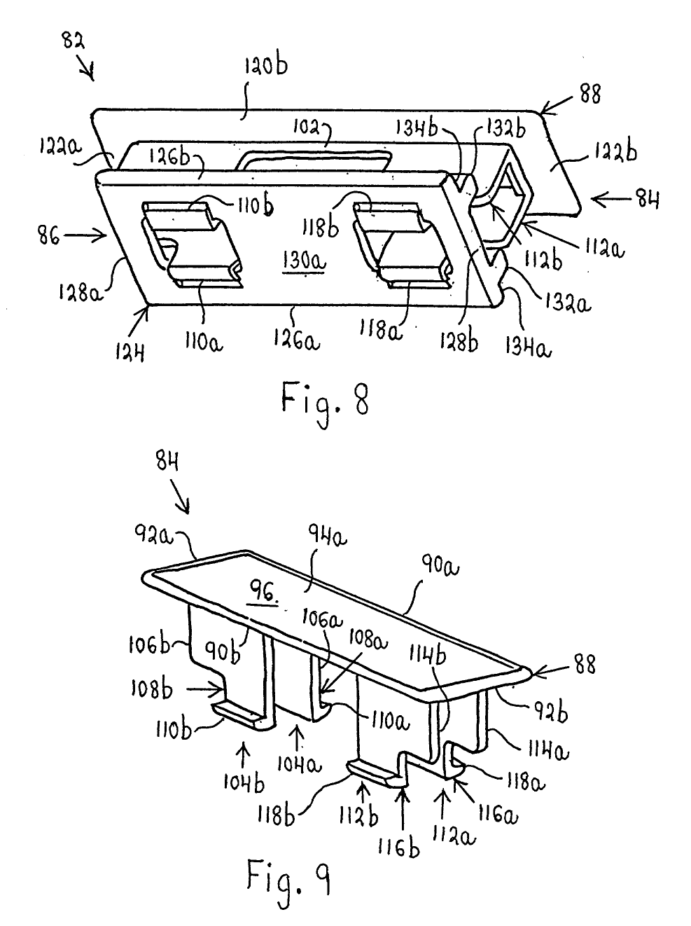

Turning to FIG. 4, the stirrup 10 further comprises a shock-absorbing or cushioning element 42 which can, for instance, be composed of rubber. The shock-absorbing element 42 has a shape similar to that of the footrest 14 and the opening 26 therein, and the shock-absorbing element 42 is designed to fit into the opening 26. The shock-absorbing element 42 has two flat parallel surfaces 42a and 42b which face in opposite directions, and the shock-absorbing element 42 further has a central opening 44 which has a shape similar to that of the opening 26 in the footrest 14 and extends from one of the flat surfaces 42a,42b to the other. When the shock-absorbing element 42 is properly positioned in the opening 26 of the footrest 14, the flat surfaces 42a,42b of the shock-absorbing element 42 are parallel or approximately parallel to the upper surface 24a and the lower surface 24b of the footrest 14. The flat surface 42a of the shock-absorbing element 42 faces in the same direction as the upper surface 24a of the footrest 14 while the flat surface 42b of the shock-absorbing element 42 faces in the same direction as the lower surface 24b of the footrest 14.

The shock-absorbing element 42 has a maximum width W which is smaller than the maximum width W1 of the opening 26 as measured at the upper surface 24a of the footrest 14 but larger than the maximum width W2 of the opening 26 as measured at the lower surface 24b of the footrest 14. This allows the shock-absorbing element 42 to be introduced into the opening 26 and removed therefrom through the side of the opening 26 at the upper surface 24a of the footrest 14. On the other hand, the shock-absorbing element 42 is unable to enter or leave the opening 26 through the side of the opening 26 at the lower surface 24b of the footrest 14.

Referring to FIGS. 1, 4, 5, 6 and 7, the stirrup 10 comprises a second shock-absorbing or cushioning element 46 discrete from the shock-absorbing element 42. The second shock-absorbing element 46 is elongated and has opposed longitudinal ends 48a and 48b. The second shock-absorbing element 46 further has two opposed longitudinally extending sides 50a and 50b which bridge the longitudinal ends 48a,48b, and the sides 50a,50b are generally straight and parallel to one another.

The second shock-absorbing element 46 is provided with a depression 52 which is bounded by a rectangle including two longer straight surface sections 54a and 54b and two shorter straight surface sections 56a and 56b. The longer surface sections 54a,54b are generally parallel to one another and to the straight sides 50a,50b of the second shock-absorbing element 46. The depression 52 further has a bottom defined by two longer sloping surface sections 58a and 58b and two shorter sloping surface sections 60a and 60b. The longer sloping surface sections 58a,58b run along the respective longer straight surface sections 54a,54b while the shorter sloping surface sections 60a,60b run along the respective shorter straight surface sections 56a,56b.

A sloping surface section 62a lies between the straight side 50a of the second shock-absorbing element 46 and the longer straight surface section 54a of the depression 52. Similarly, a sloping surface section 62b lies between the straight side 50b of the second shock-absorbing element 46 and the longer straight surface section 54b of the depression 52. The sloping surface sections 62a,62b bridge the longitudinal ends 48a,48b of the second shock-absorbing element 46, and each of the sloping surface sections 62a,62b merges into a transverse surface section 64a on the longitudinal end 48a and a transverse surface section 64b on the longitudinal end 48b. The transverse surface sections 64a,64b, which may or may not be sloped, extend transversely of the second shock-absorbing element 46 between the sloping surface sections 62a,62b. The sloping surface sections 62a,62b, as well as the transverse surface sections 64a,64b, face upward during use and can thus be considered to constitute upper surface sections of the second shock-absorbing element 46.

The second shock-absorbing element 46 has two additional surface sections 66a and 66b which face away from the sloping upper surface sections 62a,62b. The additional surface sections 66a,66b bridge the longitudinal ends 48a,48b of the second shock-absorbing element 46, and each of the additional surface sections 66a,66b merges into a transverse surface section 68a on the longitudinal end 48a and a transverse surface section 68b on the longitudinal end 48b. The transverse surface sections 68a,68b extend transversely of the second shock-absorbing element 46 between the additional surface sections 66a,66b. The additional surface sections 66a,66b, as well as the transverse surface sections 68a,68b, face downward during use and can thus be considered to constitute lower surface sections of the second shock-absorbing element 46.

An elongated opening is formed centrally of the second shock-absorbing element 46 between the sloping surface sections 58a,58b,60a,60b of the depression 52 and the lower surface sections 66a,66b,68a,68b of the second shock-absorbing element 46. The opening, which registers with the depression 52, is bounded by a rectangle including two longer straight surface sections 70a and 70b and two shorter straight surface sections 72a and 72b. The longer surface sections 70a,70b are generally parallel to one another and to the straight sides 50a,50b of the second shock-absorbing element 46.

A crosspiece 74 centered longitudinally of the opening in the second shock-absorbing element 46 bridges the longer surface sections 70a,70b of the opening. The crosspiece 74 divides the opening into two apertures 76a and 76b.

The lower surface section 66a of the second shock-absorbing element 46 is formed with an elongated rib or protuberance 78a which extends longitudinally of the second shock-absorbing element 46. Likewise, the lower surface section 66b of the second shock-absorbing element 46 is provided with an elongated rib or protuberance 78b which runs longitudinally of the second shock-absorbing element 46. The ribs 78a,78b are arranged so that, when the second shock-absorbing element 46 is properly placed on the footrest 14, the rib 78a lies proximate to or against the sloping wall segment 30a of the opening 26 in the footrest 14 while the rib 78b lies proximate to or against the opposing sloping wall segment 30b. The length of the rib 78a is equal to or less than the length of the sloping wall segment 30a of the opening 26 and the length of the rib 78b is equal to or less than the length of the sloping wall segment 30b. The ribs 78a,78b serve to position or align the second shock-absorbing element 46 on the footrest 14 transversely of the latter.

As shown in FIG. 1, the hanger 16 has an end portion 16a at the longitudinal end 20a of the footrest 14 and another end portion 16b at the opposite longitudinal end 20b of the footrest 14.

Referring to FIGS. 5 and 6 in conjunction with FIG. 1, the second shock-absorbing element 46 is provided with a recess or indentation 80a at the longitudinal end 48a of the second shock-absorbing element 46 and with a recess or indentation 80b at the longitudinal end 48b. The recesses 80a,80b are centered transversely of the second shock-absorbing element 46 and, when the second shock-absorbing element 46 is properly placed on the footrest 14, the recess 80a receives the end portion 16a of the hanger 16 whereas the recess 80b receives the end portion 16b. The recesses 80a,80b help to position or align the second shock-absorbing element 46 on the footrest 14 transversely of the latter and also serve to confine the second shock-absorbing element 46 longitudinally of the footrest 14.

The longitudinal end 48a of the second shock-absorbing element 46 is convex between the recess 80a and the respective sloping surface sections 62a,62b of the second shock-absorbing element 46. Similarly, the longitudinal end 48b of the second shock-absorbing element 46 is convex between the recess 80b and each of the sloping surface sections 62a,62b. Hence, the contours of the longitudinal ends 48a,48b of the second shock-absorbing element 46 conform to the contours of the respective longitudinal ends 20a,20b of the footrest 14.

The second shock-absorbing element 46, or at least the major part thereof, preferably comprises a body inflated with gas. This allows the second shock-absorbing element 46 to function as a gas pad or cushion. The second shock-absorbing element 46 can be made of plastic and the gas used to inflate the second shock-absorbing element 46 may be air. In the illustrated embodiment, all of the shock-absorbing element 46 except for the crosspiece 74 is inflated with gas.

Considering FIG. 8, the footrest 10 additionally comprises a clamping device 82 for fixing the shock-absorbing element 42 and the shock-absorbing element 46 to the footrest 14. The clamping device 82 is discrete from the footrest 14, the hanger 16 and the shock-absorbing elements 42,46 and includes two clamping elements 84 and 86 which are designed to lock to one another and hold the shock-absorbing elements 42,46 between them. The clamping elements 84,86 are preferably made of plastic.

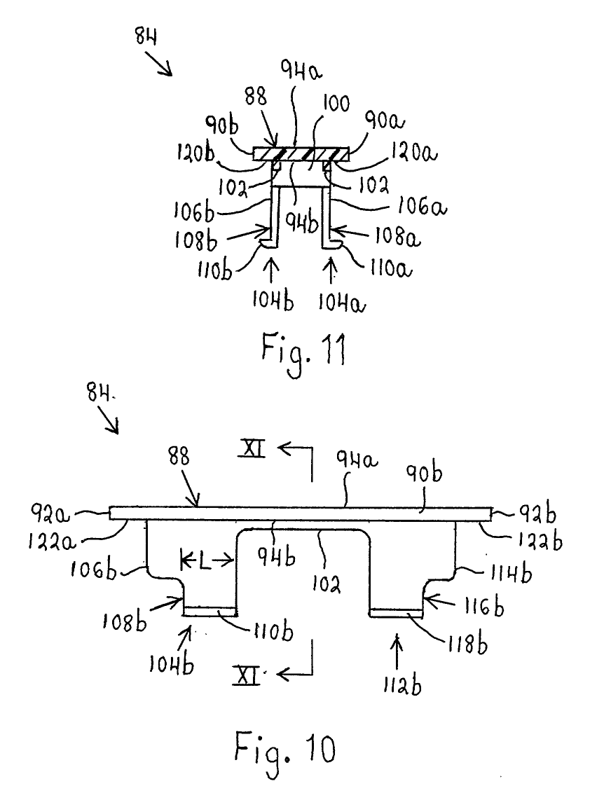

As shown in FIGS. 9, 10 and 11, the clamping element 84 includes a sheet-like rectangular section 88 bounded by two longer edges 90a and 90b extending longitudinally of the rectangular section 88 and two shorter edges 92a and 92b extending transversely of the rectangular section 88. The rectangular section 88 has opposed major sides 94a and 94b, and the major side 94a is designed to face upward during use while the major side 94b is arranged to face downward during use. The upper major side 94a is provided with a rectangular depression 96 which accommodates a sheet-like rectangular element 98. The rectangular element 98, which is observable in FIG. 1, has a nonslip surface 98a facing away from the rectangular section 88. The nonslip surface 98a faces upward during use and is arranged to support the foot of a rider employing the stirrup 10. The nonslip surface 98a constitutes a friction surface which prevents the foot of the rider from slipping out of the stirrup 10.

The rectangular section 88 is designed to fit in the depression 52 of the second shock-absorbing element 46.

The lower major side 94b of the rectangular section 88 is provided with a rectangular block 100 in the region of each transverse edge 92a,92b of the rectangular section 88 (only one of the blocks 100 is visible in the drawings). The blocks 100, which are centered transversely of the rectangular section 88, are arranged so that the lengthwise dimension of each block 100 runs in the same direction as the lengthwise dimension of the rectangular section 88. The blocks 100 are spaced in the longitudinal direction of the rectangular section 88, and two ridges 102 spaced transversely of the rectangular section 88 extend between the blocks 100. The two blocks 100 have the same dimensions, and the width of the blocks 100 is less than the width of the rectangular section 88.

The block 100 which is located nearer the transverse edge 92a of the rectangular section 88 has an L-shaped leg 104a projecting from one longitudinal side thereof and an L-shaped leg 104b projecting from the other longitudinal end thereof. The legs 104a,104b extend from the block 100 in a direction away from the rectangular section 88. The leg 104a includes a flat arm or segment 106a which runs along the respective longitudinal side of the block 100 and has a length, as considered longitudinally of the rectangular section 88, which is equal to or approximately equal to the length of the respective block 100. Similarly, the leg 104b includes a flat arm or segment 106b which runs along the respective longitudinal side of the block 100 and has a length, as considered longitudinally of the rectangular section 88, which is equal to or approximately equal to the length of the respective block 100. The leg 104a further includes a flat arm or segment 108a which is coplanar with and generally perpendicular to the arm 106a while the leg 104b further includes a flat arm or segment 108b which is coplanar with and generally perpendicular to the arm 106b. The arms 108a,108b extend from the arms 106a,106b in a direction away from the rectangular section 88, and each arm 108a,108b has a free end remote from the respective arm 106a,106b. At the free end of the arm 108a is a projection or protrusion 110a extending away from the arm 108b and at the free end of the arm 108b is a projection or protrusion 110b extending away from the arm 108a.

The block 100 which is located nearer the transverse edge 92b of the rectangular section 88 has an L-shaped leg 112a projecting from one longitudinal side thereof and an L-shaped leg 112b projecting from the other longitudinal end thereof The legs 112a,112b extend from the block 100 in a direction away from the rectangular section 88. The leg 112a includes a flat arm or segment 114a which runs along the respective longitudinal side of the block 100 and has a length, as considered longitudinally of the rectangular section 88, which is equal to or approximately equal to the length of the respective block 100. Similarly, the leg 112b includes a flat arm or segment 114b which runs along the respective longitudinal side of the block 100 and has a length, as considered longitudinally of the rectangular section 88, which is equal to or approximately equal to the length of the respective block 100. The leg 112a further includes a flat arm or segment 116a which is coplanar with and generally perpendicular to the arm 114a while the leg 112b further includes a flat arm or segment 116b which is coplanar with and generally perpendicular to the arm 114b. The arms 116a,116b extend from the arms 114a,114b in a direction away from the rectangular section 88, and each arm 116a,116b has a free end remote from the respective arm 114a,114b. At the free end of the arm 116a is a projection or protrusion 118a extending away from the arm 116b and at the free end of the arm 116b is a projection or protrusion 118b extending away from the arm 116a.

The legs 104a,112a are coplanar as are the legs 104b,112b. The arm 108a and projection 110a, the arm 108b and projection 110b, the arm 116a and projection 118a and the arm 116b and projection 118b all have the same length L as measured longitudinally of the clamping element 84.

The legs 104a,104b have at least some resilience or elasticity, and the resilience or elasticity is sufficient to allow the legs 104a,104b to shift towards one another when squeezed and to snap back to their original positions when released. The legs 112a,112b are likewise sufficiently resilient or elastic to move towards one another when squeezed and to snap back to the respective starting positions when released.

The blocks 100 which support the legs 104a,104b,112a,112b, the ridges 102 extending between the blocks 100 and the legs 104a,104b,112a,112b are spaced from the longitudinal edges 90a,90b and the transverse edges 92a,92b of the rectangular section 88 of the clamping element 84. Consequently, rims or overhangs 120a and 120b extending along the respective longitudinal edges 90a and 90b, as well as rims or overhangs 122a and 122b extending along the respective transverse edges 92a and 92b, are formed on the rectangular section 88.

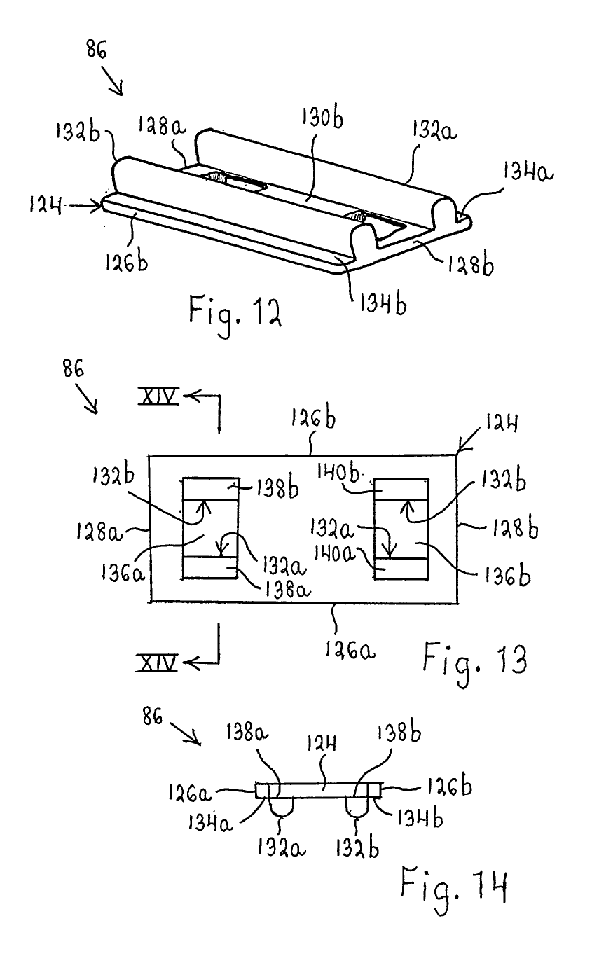

Considering FIGS. 8, 12, 13 and 14, the clamping element 86 includes a sheet-like rectangular section 124 bounded by two longer edges 126a and 126b extending longitudinally of the rectangular section 124 and two shorter edges 128a and 128b extending transversely of the rectangular section 124. The rectangular section 124 has opposed major sides 130a and 130b, and the major side 130a is designed to face downward during use while the major side 130b is arranged to face upward during use.

Two ribs or protuberances 132a and 132b run along the lower major side 130a of the rectangular section 124 longitudinally of the latter, and each of the ribs 132a,132b extends from the transverse edge 128a of the rectangular section 124 to the transverse edge 128b thereof. The rib 132a is located near the longitudinal edge 126a of the rectangular section 124 but is spaced therefrom so that a rim or overhang 134a is formed alongside the longitudinal edge 126a. The other rib 132b is located near the longitudinal edge 126b of the rectangular section 124, and the rib 132b is spaced from the longitudinal edge 126b in order to produce a rim or overhang 134b alongside the edge 126b.

Each of the ribs 132a,132b has a surface which faces the other of the ribs 132a,132b. The distance between these facing surfaces is greater than the distance between the legs 104a,104b of the clamping element 84 and greater than the distance between the legs 112a,112b of the clamping element 84. On the other hand, the distance between the facing surfaces of the ribs 132a,132b is smaller than the distance between the projections 110a,110b on the legs 104a,104b and smaller than the distance between the projections 118a,118b on the legs 112a,112b.

Each of the ribs 132a,132b also has a surface which faces away from the other of the ribs 132a,132b. The distance between such surfaces is equal to or slightly less than the maximum width W2 of the opening 26 in the footrest 14 as measured at the lower surface 24b of the footrest 14. Furthermore, the length of the clamping element 86 is equal to or slightly less than the length of the strip-like sections 40a,40b forming part of the lower surface 24b of the footrest 14.

The rectangular section 124 of the clamping element 86 is provided with a rectangular cutout or aperture 136a nearer the transverse edge 128a of the rectangular section 124 and another rectangular cutout or aperture 136b nearer the transverse edge 128b. Each of the cutouts 136a,136b extends from the major surface 130a to the major surface 130b of the rectangular section 124. The length of each cutout 136a,136b as measured in the longitudinal direction of the rectangular section 124 exceeds the width L of the arm 108a and projection 110a, the width L of the arm 108b and projection 110b, the width L of the arm 116a and projection 118a and the width L of the arm 116b and projection 1118b of the clamping element 84.

The cutouts 136a,136b are centered transversely of the rectangular section 124, and the width of each cutout 136a,136b as measured in the transverse direction of the rectangular section 124 exceeds the distance between the ribs 132a,132b. Consequently, a portion of each rib 132a,132b is exposed in either of the cutouts 136a,136b. The exposed portion of the rib 132a in the cutout 136a forms a shoulder or abutment 138a while the exposed portion of the rib 132b in the cutout 136a defines a shoulder or abutment 138b. Similarly, the exposed portion of the rib 132a in the cutout 136b defines a shoulder or abutment 140a whereas the exposed portion of the rib 132b in the cutout 136b forms a shoulder or abutment 140b.

One manner of assembling the stirrup 10 is as follows:

The shock-absorbing element 42 is inserted in the opening 26 of the footrest 14 through the side of the opening 26 at the upper surface 24a of the footrest 14. The shock-absorbing element 42 is positioned with the flat surface 42a thereof facing in the same direction as the upper surface 24a of the footrest 14 and with the flat surface 42b thereof facing in the same direction as the lower surface 24b of the footrest 14. Since, as mentioned previously, the maximum width W of the shock-absorbing element 42 is greater than the maximum width W2 of the opening 26 as measured at the lower surface 24b of the footrest 14, the shock-absorbing element 42 is prevented from leaving the opening 26 through the side of the opening 26 at the lower surface 24b of the footrest 14. The flat surface 42a of the shock-absorbing element 42 is recessed in the opening 26 to allow the ribs 78a,78b of the second shock-absorbing element 46 to enter the opening 26. Similarly, the flat surface 42b of the shock-absorbing element 42 is recessed in the opening 26 to allow the ribs 132a,132b of the clamping element 86 to enter the opening 26.

Once the shock-absorbing element 42 has been inserted in the opening 26 of the footrest 14, the second shock-absorbing element 46 is placed on the footrest 14. The second shock-absorbing element 46 is positioned on the upper surface 24a of the footrest 14 with the depression 52 in the second shock-absorbing element 46 facing the hanger 16 of the footrest 14. The lower surface section 66a of the second shock-absorbing element 46 rests on the strip-like section 36a of the upper footrest surface 24a and the lower surface section 66b of the-second shock-absorbing element 46 rests on the strip-like section 36b. In addition, the lower surface section 68a of the second shock-absorbing element 46 rests on the curved section 34a of the upper footrest surface 24a whereas the lower surface section 68b of the second shock-absorbing element 46 rests on the curved section 34b.

The ribs 78a,78b of the second shock-absorbing element 46 are inserted in the opening 26 of the footrest 14 with the rib 78a running alongside the sloping wall segment 30a of the opening 26 and the rib 78b running alongside the sloping wall segment 30b. Moreover, the end portion 16a of the footrest hanger 16 is introduced into the recess 80a of the second shock-absorbing element 46 while the end portion 16b of the hanger 16 is introduced into the recess 80b. The ribs 78a,78b and the recesses 80a,80b serve to locate the second shock-absorbing element 46 on the footrest 14.

When the second shock-absorbing element 46 has been properly positioned on the footrest 14, the shock-absorbing element 42 is confined in the opening 26 of the footrest 14.

After the second shock-absorbing element 46 has been placed on the footrest 14, the clamping element 86 is placed and held against the footrest 14. The clamping element 86 is positioned on the lower surface 24b of the footrest 14 with the shoulders 138a,138b,140a,140b of the clamping element 86 facing away from the shock-absorbing elements 84,86. The rim 134a of the clamping element 86 rests against the strip-like section 40a of the lower footrest surface 24b while the rim 134b of the clamping element 86 rests against the strip-like section 40b. The cutout 136a in the clamping element 86 registers with the central opening 44 in the shock-absorbing element 42 and with the aperture 76a in the second shock-absorbing element 46 whereas the cutout 136b in the clamping element 86 registers with the central opening 44 in the shock-absorbing element 42 and with the aperture 76b in the second shock-absorbing element 46.

The ribs 132a,132b of the clamping element 86 are inserted in the opening 26 of the footrest 14 with the rib 132a running alongside the strip-like section 40a of the lower footrest surface 24b and the rib 132b running alongside the strip-like section 40b. The ribs 132a,132b function to locate the clamping element 86 on the footrest 14.

Once the clamping element 86 has been positioned on the footrest 14, the legs 104a,104b of clamping element 84 are successively passed through the aperture 76a of the second shock-absorbing element 46 and the opening 44 of the shock-absorbing element 42. Likewise, the legs 112a,112b of the clamping element 84 are successively passed through the aperture 76b of the second shock-absorbing element 46 and the opening 44 of the shock-absorbing element 42. If necessary or desirable, the legs 104a,104b may be urged towards one another in order to facilitate passage of the legs 104a,104b through the aperture 76a and the opening 44. Similarly, the legs 111a,112b can be urged towards each other to ease passage of the legs 112a,112b through the aperture 76b and the opening 44.

As mentioned earlier, the distance between the ribs 132a,132b of the clamping element 86 smaller than the distance between the projections 110a,110b on the legs 104a,104b and smaller than the distance between the projections 118a,118b on the legs 112a,112b.

When the projections 110a,110b reach the ribs 132a,132b and the rectangular section 88 of the clamping element 84 is pushed in a direction towards the clamping element 86, the ribs 132a,132b urge the projections 110a,110b towards one another. This allows the projections 110a,110b to pass between the ribs 132a,132b and to enter the cutout 136a in the clamping element 86. As the projections 110a,110b move into the cutout 136a, the projections 110a,110b clear the ribs 132a,132b. Once the projections 111a,110b have cleared the ribs 132a,132b, the legs 104a,104b carrying the respective projections 110a,110b are free to move away from one another. Since the legs 104a,104b are resilient, the legs 104a,104b move back to their original positions with a snap action as soon as the projections 110a,110b have passed the ribs 132a,132b. Upon return of the legs 104a,104b to their original positions, the projection 110a slides over the shoulder 138a of the rib 132a while the projection 110b slides over the shoulder 138b of the rib 132b. Consequently, the clamping members 84,86 are locked to one another and to the footrest 14 with the shock-absorbing elements 42,46 clamped between them.

Similarly, when the projections 118a,118b on the legs 112a,112b reach the ribs 132a,132b and the rectangular section 88 of the clamping element 84 is pushed in a direction towards the clamping element 86, the ribs 132a,132b urge the projections 118a,118b towards one another. This permits the projections 118a,118b to pass between the ribs 132a,132b and to enter the cutout 136b in the clamping element 86. As the projections 118a,118b move into the cutout 136b, the projections 118a,118b clear the ribs 132a,132b. Once the projections 118a,118b have cleared the ribs 132a,132b, the legs 112a,112b carrying the respective projections 118a,118b are free to move away from one another. Inasmuch as the legs 112a,112b are resilient, the legs 112a,112b move back to their original positions with a snap action as soon as the projections 118a,118b have passed the ribs 132a,132b. Upon return of the legs 112a,112b to their original positions, the projection 118a slides over the shoulder 140a of the rib 132a while the projection 118b slides over the shoulder 140b of the rib 132b.

As the projections 110a,110b and the projections 118a,118b move along the ribs 132a,132b and through the respective cutouts 136a,136b of the clamping member 86, the rectangular section 88 of the clamping member 84 enters the depression 52 of the second shock absorbing element 46. In the locked condition of the clamping members 84,86, the rectangular section 88 lies in the depression 52 with the rim 120a of the rectangular section 88 resting on the sloping surface section 58a of the second shock-absorbing element 46, the rim 120b resting on the 6 sloping surface section 58b, the rim 122a resting on the sloping surface section 60a and the rim 122b resting on the sloping surface section 60b.

To disassemble the stirrup 10, the projections 110a,110b are urged towards one another sufficiently to remove the projections 110a,110b from the respective shoulders 138a,138b of the ribs 132a,132b. Likewise, the projections 118a,118b are urged in a sense to slide the projections 118a,118b off the corresponding shoulders 140a,140b. Once the projections 110a,110b,118a,118b have been removed from the shoulders 138a,138b,140a,140b, the clamping element 86 can be removed from the footrest 14. The shock-absorbing elements 42,46 and the clamping element 84 are also free to be removed from the footrest 14, and the legs 104a,104b,112a,112b of the clamping element 84 can be withdrawn from the shock-absorbing elements 42,46.

Due to the fact that the clamping device 82 is separate from the footrest 14, the hanger 16 and the shock-absorbing elements 42,46, the stirrup 10 has a great degree of versatility. For instance, the stirrup 10 is not restricted to a single shock-absorbing element but can employ a plurality of such elements. These shock-absorbing elements can be made of different materials so that variations in the shock-absorbing properties of the stirrup can be achieved. Moreover, while the nonslip surface of a prior art stirrup must be formed on the shock-absorbing element of the stirrup, this is not the case for the stirrup 10. Thus, as illustrated, it is possible to provide the nonslip surface of the stirrup 10 on the clamping device 82. This enables the characteristics of the nonslip surface to be changed without changing the shock-absorbing properties of the stirrup 10.

Various modifications are possible within the meaning and range of equivalence of the appended claims.

I claim:

1. A stirrup comprising:
a support for a foot;
at least one shock-absorbing element; and
means for releasably clamping said one shock-absorbing element to said support, said clamping means being discrete from said one shock-absorbing element.

2. The stirrup of claim 1, further comprising a suspending element for suspending said support from a saddle, said one shock-absorbing element being provided with at least one recess designed to receive said suspending element and position said one shock-absorbing element on said support when said one shock-absorbing element is clamped to said support.

3. The stirrup of claim 1, wherein said support is provided with an opening and said one shock-absorbing element is provided with at least one rib designed to project into said opening and position said one shock-absorbing element on said support when said one shock-absorbing element is clamped to said support.

4. The stirrup of claim 1, wherein said clamping means comprises a clamping element having two pairs of legs which are spaced from one another, the legs of each pair being resiliently shiftable towards and away from each other to permit clamping of said one shock-absorbing element to said support by snap action, and said one shock-absorbing element being provided with an aperture for each of said pairs of legs.

5. The stirrup of claim 1, wherein said clamping means comprises a clamping element having a section with a nonslip surface, said one shock-absorbing element being provided with a depression for said section.

6. The stirrup of claim 1, further comprising an additional shock-absorbing element discrete from said support and said clamping means, said clamping means being designed to releasably clamp both of said shock-absorbing elements to said support.

7. The stirrup of claim 6, wherein said support has a first side, an opposite second side and an opening having a first width at said first side and a smaller second width at said second side, said additional shock-absorbing element being designed to be accommodated in said opening and having a width smaller than said first width and larger than said second width.

8. The stirrup of claim 1, wherein a major part of said one shock-absorbing element is inflated with gas.

9. The stirrup of claim 8, wherein said gas comprises air.

10. The stirrup of claim 1, wherein said support has a first side, an opposite second side and an opening extending from said first side to said second side, said one shock-absorbing element being designed to be in register with said opening, and said clamping means including a first clamping element designed to bear against said one shock-absorbing element and a second clamping element designed to bear against said second side.

11. The stirrup of claim 10, wherein said second clamping element is provided with at least one protuberance designed to project into said opening and position said second clamping element on said support when said one shock-absorbing element is clamped to said support.

12. The stirrup of claim 10, wherein said one shock-absorbing element is designed to bear against said first side.

13. The stirrup of claim 10, wherein one of said clamping elements has at least one pair of legs and said one shock-absorbing element is provided with a first aperture for said legs, the other of said clamping elements being formed with a second aperture for said legs, and said second aperture being arranged to register with said first aperture when said one shock-absorbing element is clamped to said support, said legs being resiliently shiftable towards and away from each other between a first position in which said legs are spaced by a larger distance to prevent passage of both of said legs through said second aperture and a second position in which said legs are spaced by a smaller distance to permit passage of both of said legs through said second aperture.

14. The stirrup of claim 13, wherein at least one of said legs has a free end designed to pass through said second aperture and a projection at said free end extending away from the other of said legs, said other clamping element being provided with a shoulder for said projection.

15. The stirrup of claim 1, wherein said clamping means comprises a first clamping element and a second clamping element having cooperating portions for locking said clamping elements to one another.

16. The stirrup of claim 15, wherein each of said clamping elements consists at least predominantly of plastic.

17. A method of assembling a stirrup comprising the steps of:
providing a support for a foot; and
releasably clamping at least one shock-absorbing element to said support using clamping means discrete from said one shock-absorbing element.

18. The method of claim 17, wherein said one shock-absorbing element is provided with a recess and said support is provided with a suspending element for suspending said support from a saddle; and further comprising the step of inserting said suspending element in said recess to position said one shock-absorbing element on said support.

19. The method of claim 17, wherein said one shock-absorbing element is provided with a rib and said support is provided with an opening; and further comprising the step of inserting said rib in said opening to position said one shock-absorbing element on said support.

20. The method of claim 17, wherein said one shock-absorbing element has two apertures and said clamping means includes a clamping element having two pairs of legs, the clamping step comprising passing one of said pairs of legs through one of said apertures and the other of said pairs of legs through the other of said apertures, resiliently urging the legs of each pair towards one another, and allowing the legs of each pair to resiliently spring back from one another so as to fix said one shock-absorbing element to said support by snap action.

21. The method of claim 17, wherein said clamping means comprises a clamping element having a section with a nonslip surface, the clamping step including recessing said section in said one shock-absorbing element.

22. The method of claim 17, wherein said support is provided with an opening; and further comprising the step of recessing an additional shock-absorbing element in said opening, the clamping step including confining said additional shock-absorbing element in said opening using said one shock-absorbing element.

23. The method of claim 17, wherein a major part of said one shock-absorbing element is inflated with gas.

24. The method of claim 23, wherein said gas comprises air.

25. The method of claim 17, wherein said clamping means comprises a first clamping element and a second clamping element, the clamping step including urging said first clamping element against said one shock-absorbing element and urging said second clamping element against said support.

26. The method of claim 25, wherein said second clamping element is provided with a protuberance and said support is provided with an opening; and further comprising the step of inserting said protuberance in said opening to position said second clamping element on said support.

27. The method of claim 25, wherein the clamping step comprises urging said one shock-absorbing element against said support.

28. The method of claim 25, wherein one of said clamping elements has at least one pair of legs and the other of said clamping elements is formed with an aperture for said legs, the clamping step resiliently urging said legs towards one another, passing both of said legs through said aperture, and allowing said legs to resiliently spring back from one another so as to fix said one shock-absorbing element to said support by snap action.

29. The method of claim 28, wherein at least one of said legs has a free end and a projection at said free end extending away from the other of said legs, the clamping step including recessing said projection in said other clamping element.

30. The method of claim 17, wherein said clamping means comprises a first clamping element and a second clamping element, the clamping step including locking said first clamping element and said second clamping element to one another, and each of said clamping elements consisting at least predominantly of plastic.
